(19) United States
(12) Patent Application Publication
(10) Pub. No.: US 2016/0210638 A1
(43) Pub. Date: Jul. 21, 2016

(54) SERVER AND METHOD FOR GENERATING EVALUATION INFORMATION OF SHOP, AND DEVICE FOR RECEIVING EVALUATION INFORMATION

(71) Applicant: MAKTB INC., Seoul (KR)

(72) Inventor: Hyun KIM, Seoul (KR)

(73) Assignee: MAKTB INC., Seoul (KR)

(21) Appl. No.: 14/913,728

(22) PCT Filed: Aug. 26, 2013
(86) PCT No.: PCT/KR2013/007625

§ 371 Date: Feb. 23, 2016

(51) Int. Cl. G06Q 30/02; G01S 19/13; G06F 17/30

(52) U.S. Cl. CPC G06Q 30/0201; G06F 17/3053; G01S 19/13

(57) ABSTRACT

An evaluation information generating server includes a determination unit configured to determine whether a device of a user is located within an area of a shop; a visiting information management unit configured to update visiting information of the user with regard to the shop based on the determination result; a grade assigning unit configured to assign a grade of the user based on the visiting information; and an evaluation information generating unit configured to generate evaluation information of the shop based on grades of a plurality of users.

### TECHNICAL FIELD

The embodiments described herein pertain generally to a server and a method for generating evaluation information of a shop, and a device that receives the evaluation information.

### BACKGROUND

To our contemporaries who are living in the Internet era, it is very common to search for an online site of a shop to refer to reviews and evaluations of other users before visiting the shop. The users that have been to the shop may upload evaluations of the shop as well as pictures thereof on the online site of the shop, and, thus, other users can check exact information of the shop through the online site.

Generally, the evaluations of the shop mostly rely on subjective opinions of the users that have visited the shop before. Thus, if the number of evaluators is not sufficiently large, objectivity of the evaluations may not be ensured. Further, there is also a concern that an ill-intended user may intentionally manipulate evaluation itself. Actually, it frequently happens that a shop having received positive evaluation at a certain blog is very opposite to what is said. In this regard, there has is a demand for a more advanced evaluation approach capable of accomplishing highly reliable and objective evaluation of a shop.

With regard to evaluation of a shop, Korean Patent Laid-open Publication No. 2009-0106797 describes a system and a method of processing a request for evaluation of an interest product and a reply thereto in wired/wireless Internet so that a user can request evaluation information of the product and refer to the evaluation information presented by a multiple number of other users before the user decides whether to buy the product.

### DISCLOSURE OF THE INVENTION

### Problems to be Solved by the Invention

Example embodiments of the present disclosure provide, an evaluation information generating server, a method and a device capable of providing more objective and reliable evaluation information of a shop. Further, the example embodiments of the present disclosure also provide an evaluation information generating server, a method and a device capable of reflecting evaluations of customers that have actually visited a shop by sorting regular customers and utilizing logs of the regular customer. Furthermore, the example embodiments of the present disclosure also provide an evaluation information generating server, a method and a device capable of accomplishing more exact evaluation of a shop by sorting customers into different grades based on the number of visits of the customers to the shop and the number of purchases that have been made by the customers and by applying weighted values for evaluation by the grades.

However, the problems sought to be solved by the present disclosure are not limited to the above description and other problems can be clearly understood by those skilled in the art from the following description.

### Means for Solving the Problems

As means for solving the problems, an example embodiment may provide an evaluation information generating server including a determination unit configured to determine whether a device of a user is located within an area of a shop; a visiting information management unit configured to update visiting information of the user with regard to the shop based on the determination result; a grade assigning unit configured to assign a grade of the user based on the visiting information; and an evaluation information generating unit configured to generate evaluation information of the shop based on grades of a plurality of users and the score.

Further, according to an example embodiment, the visiting information includes at least one of a number of visits and a frequency of visits, and the grade assigning unit is further configured to assign the grade of the user based on at least one of the number of visits and the frequency of visits.

Further, according to an example embodiment, the grade assigning unit is configured to assign a regular customer grade to the user when the number of visits is equal to or larger than a threshold value.

Further, according to an example embodiment, the evaluation information generating unit is configured to generate the evaluation information of the shop based on the grades of the plurality of users and scores of the plurality of users.

Further, according to an example embodiment, the evaluation information generating unit is configured to generate the evaluation information by applying a weighted value to each of the scores of the plurality of users according to the grade of each of the plurality of users, and the grade of each of the plurality of users is any one of a first grade, a second grade and a third grade.

Further, according to an example embodiment, the determination unit is configured to determine whether the device of the user is located within the area of the shop based on at least one of position information of the shop and position information of the device.

Further, another example embodiment may provide an evaluation information generating method including determining whether a device of a user is located within an area of a shop; updating visiting information of the user with regard to the shop based on the determination result; assigning a grade of the user based on the visiting information; and generating evaluation information of the shop based on the grade of the user.

Further, still another example embodiment may provide a device including a position information generating unit configured to generate position information of the device when the device is located within an area of the shop; an input unit configured to receive a score of the shop which is input through a user interface; an transmitting unit configured to transmit the position information and the score to the evaluation information generating server; and an receiving unit configured to receive evaluation information of the shop from the evaluation information generating server. The evaluation information is changed based on the score and a grade of a user of the device.

Further, still another example embodiment may provide an evaluation information receiving method including generating position information of the device when the device is located within an area of the shop; receiving a score of the shop which is input through a user interface; transmitting the position information and the score to the evaluation information generating server; and receiving evaluation information of the shop from the evaluation information generating server. The evaluation information is changed based on the score and a grade of a user of the device.

### Effect of the Invention

According to the example embodiments, it is possible to provide, an evaluation information generating server, a method and a device capable of providing more objective and reliable evaluation information of a shop. Further, it is also possible to provide an evaluation information generating server, a method and a device capable of reflecting evaluations of customers that have actually visited a shop by sorting regular customers and utilizing logs of the regular customer. Furthermore, it is also possible to provide an evaluation information generating server, a method and a device capable of accomplishing more exact evaluation of a shop by sorting customers into different grades based on the number of visits of the customers to the shop and the number of purchases that have been made by the customers and by applying weighted values for evaluation by the grades.

### BRIEF DESCRIPTION OF THE DRAWINGS

FIG. 1 is a block diagram illustrating an evaluation information sharing system according to an example embodiment.

FIG. 2 is a block diagram illustrating an evaluation information generating server according to the example embodiment.

FIG. 3 is a block diagram for describing an operation of the evaluation information generating server according to an example embodiment.

FIG. 4 is a flowchart for describing an example process of determining a grade of a customer.

FIG. 5 is a diagram for describing a process of determining evaluation information of a shop by using weighted values for each customer grade.

FIG. 6 is a flowchart for describing an example process of generating evaluation information.

FIG. 7 is a block diagram illustrating a device according to an example embodiment.

FIG. 8 is a flowchart for describing a method of generating evaluation information according to an example embodiment.

### MODE FOR CARRYING OUT THE INVENTION

Hereinafter, example embodiments will be described in detail so that inventive concept may be readily implemented by those skilled in the art. However, it is to be noted that the present disclosure is not limited to the example embodiments and examples but can be realized in various other ways. In drawings, parts not directly relevant to the description are omitted to enhance the clarity of the drawings, and like reference numerals denote like parts through the whole document.

Through the whole document, the terms “connected to” or “coupled to” are used to designate a connection or coupling of one element to another element and include both a case where an element is “directly connected or coupled to” another element and a case where an element is “electronically connected or coupled to” another element via still another element. Further, through the whole document, the term “comprises or includes” and/or “comprising or including” used in the document means that one or more other components, steps, operation and/or existence or addition of elements are not excluded in addition to the described components, steps, operation and/or elements unless context dictates otherwise.

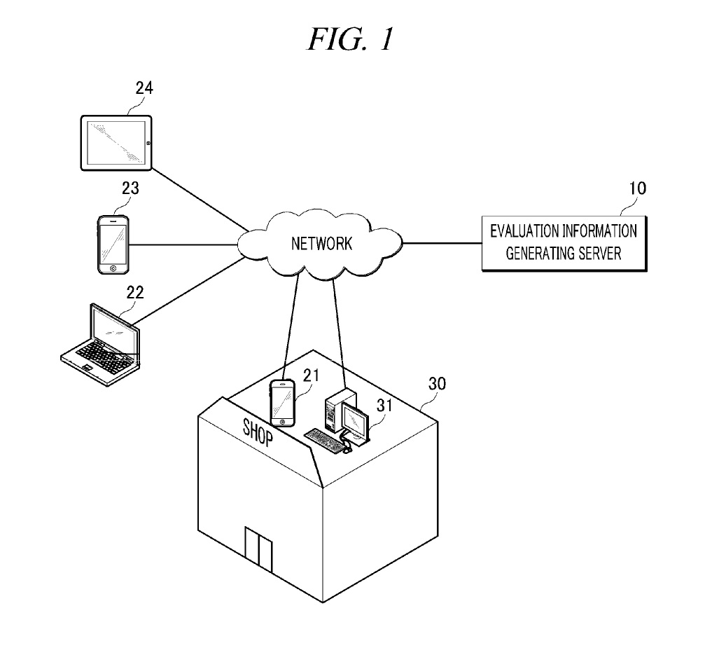

FIG. 1 is a block diagram illustrating an evaluation information sharing system according to an example of the present disclosure. As depicted in FIG. 1, the evaluation information sharing system includes an evaluation information generating server 10, a plurality of devices 21 to 24, and a shop device 31 installed in a shop 30. The evaluation information sharing system of FIG. 1 is, however, nothing more than an example according to one example embodiment of the present disclosure, and the example shown in FIG. 1 is not intended to limit the present disclosure at all. That is, the evaluation information sharing system may be configured differently from the example shown in FIG. 1 according to various other example embodiments of the present disclosure. By way of example, the evaluation information sharing system may further include a network base station and a wireless AP (Access Point).

Individual constituent components of the evaluation information sharing system of FIG. 1 are connected to each other through a network. The network implies a linking structure that allows individual nodes such as terminals and servers to exchange information therebetween. Examples of this network include, but not limited to, a 3GPP (3^{rd} Generation Partnership Project) network, a LTE (Long Term Evolution) network, a WIMAX (World Interoperability for Microwave Access) network, Internet, a LAN (Local Area Network), Wireless LAN (Wireless Local Area Network), a WAN (Wide Area network), a PAN (Personal Area network), a Bluetooth network, a satellite broadcasting network, an analog broadcasting network, a DMB (Digital Multimedia Broadcasting) network, and so forth.

The evaluation information generating server 10 is configured to determine whether the device 21 is located within an area of the shop 30. For this purpose, the evaluation information generating server 10 may use position information of the device 21 and position information of the shop 30. Here, the position information of the device 21 or the shop 30 may be at least one of GPS (Global Positioning System) information of the device 21 or the shop device 31, base station information of the device 21 or the shop device 31, and AP (Access Point) information of the device 21 or the shop device 31. According to one example embodiment of the present disclosure, the evaluation information generating server 10 may request and receive at least one of the position information of the device 21, the position information of the shop 30 and the position information of the shop device 31.

The evaluation information generating server 10 is configured to record and update visiting information of a user with regard to the shop 30. At this time, the evaluation information generating server 10 may utilize the position information of the device 21 of the user. For example, the evaluation information generating server 10 may determine whether the device 21 of the user is located within the area of the shop 30 based on the position information of the device 21, and, depending on the determination result, the evaluation information generating server 10 may add one (1) to the number of visits of the user to the shop 30. As another example, the evaluation information generating server 10 may determine whether the user has purchased a certain product by using the device 21 or the shop device 31, and, depending on the determination result, the evaluation information generating server 10 may add one (1) to the number of purchases of the user with regard to the shop 30. Further detailed description will be provided below.

The evaluation information generating server 10 is configured to determine a grade of a user based on visiting information of each user. As an example, the grade may be any one of low, middle and high classes which are distinguished based on the number of visits to the shop 30, or may be any one of first, second and third grades which are distinguished based on the number of purchases in the shop 30.

The evaluation information generating server 10 is configured to generate evaluation information of the shop 30 based on grades of a plurality of user. As an example, the evaluation information may be a sum or an average of plural scores corresponding to the grades of each of the plurality of users. As another example, the evaluation information may be a grade (for example, any one of first to fifth grades) corresponding to the sum or the average of the scores.

The evaluation information generating server 10 is configured to receive a user's evaluation score of the shop 30 from the device 21 of the user. In the same context, the evaluation information generating server 10 is also configured to receive an evaluation score from at least one of the other devices 22 to 24 which have ever visited the shop 30.

The evaluation information generating server 10 is further configured to generate evaluation information of the shop 30 based on evaluation scores received from a plurality of devices. For example, the evaluation information may be a sum or an average of the evaluation scores of the shop. As another example, the evaluation information may be a grade (for example, any one of first to fifth grades) corresponding to the sum or the average of the evaluation scores.

The evaluation information generating server 20 is further configured to generate evaluation information of the shop 30 based on evaluation scores of a plurality of users and weighted values for each grade of the plurality of users. Further detailed description regarding this will be provided below.

The evaluation information generating server 10 transmits the evaluation information of the shop 30 to a plurality of devices. Here, the evaluation information generating server 10 may transmit the evaluation information to each of the plurality of devices in response to a request therefrom, or may transmit the evaluation information periodically or randomly to each of the plurality of devices.

The evaluation information generating server 10 is also configured to transmit a reward or target information to the device 21 as well as the evaluation information. Here, an example of the reward may be a coupon, and an example of the target information may be a target advertisement.

The plurality of devices 21 to 24 are configured to transmit their individual evaluations of the shop 30 to the evaluation information generating server 10. For this purpose, each of the plurality of devices 21 to 24 may receive an individual evaluation of the shop 30 inputted through each corresponding user interface, and may send the received individual evaluation to the evaluation information generating server 10. An example of the user interface may be, by way of non-limiting example, a hardware button, a voice recognition interface, a gesture recognition interface, a touch interface, or the like. Further, an example of the individual evaluation may be an evaluation score per user or an evaluation comment per user.

Each of the plurality of devices 21 to 24 is configured to generate each position information thereof when they are located within the area of the shop 30. Further, each of the devices 21 to 24 is also configured to transmit the generated position information to the evaluation information generating server 10.

The plurality of devices 21 to 24 is also configured to receive the evaluation information of the shop 30 from the evaluation information generating server 10. Further, each of the devices 21 to 24 may display the received evaluation information on a display.

According to various example embodiments, the plurality of devices 21 to 24 may be of various types. For example, each of the plurality of devices 21 to 24 may be implemented by a TV device, a computer or a mobile terminal capable of accessing a remote sever through a network. Here, an example of the TV device may include a smart TV, an IPTV setup box, and the like; an example of the computer may include a desktop computer, a laptop computer, a notebook computer equipped with a web browser, and the like; and an example of the mobile terminal may include, as a wireless communication device having portability and mobility, any of various kinds of handheld wireless communication devices such as a PCS (Personal Communication System), a GSM (Global System for Mobile communications), a PDC (Personal Digital Cellular), a PHS (Personal Handyphone System), a PDA (Personal Digital Assistant), an IMT (International Mobile Telecommunication)-2000, a CDMA (Code Division Multiple Access)-2000, a W-CDMA (W-Code Division Multiple Access), a Wibro (Wireless Broadband Internet) terminal, a smartphone, a tablet PC, and so forth. Here, however, it should be noted that the devices 21 to 24 are not limited to the examples shown in FIG. 1 or specified above.

The shop 30 is a store that sells a product and a service. The product and the service sold in the shop may be online or offline product and service. The shop 30 includes the shop device 31 therein. The shop device 31 is connected to the evaluation information generating server 100 through a network. The shop device 31 may be a payment device configured to perform a payment process for the service or the product, or may be a near field communication device capable of determining, when the device 21 is located close to it, whether the device 21 is adjacent to it through near field communications.

Below, operations of the individual constituent components of the evaluation information sharing system of FIG. 1 will be elaborated.

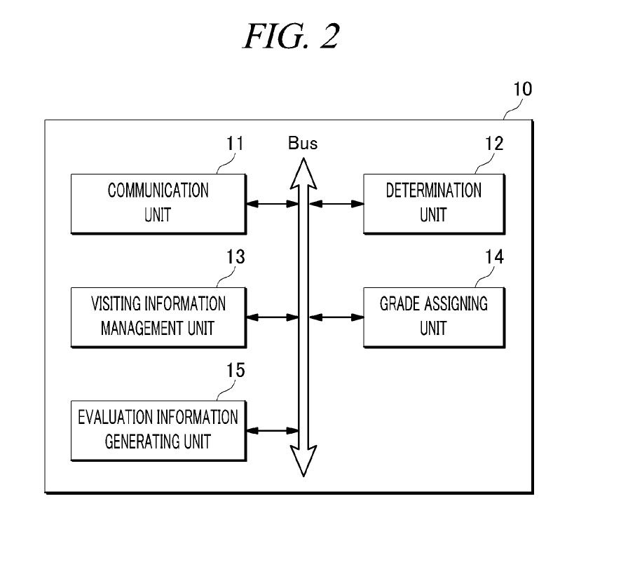

FIG. 2 is a block diagram illustrating the evaluation information generating server according to an example embodiment of the present disclosure. As depicted in FIG. 2, the evaluation information generating server 10 may include a communication unit 11, a determination unit 12, a visiting information management unit 13, a grade assigning unit 14 and an evaluation information generating unit 15. Here, however, it should be noted that the evaluation information generating server 10 shown in FIG. 2 is only an example of the present disclosure, and various modifications may be made based on the constituent components depicted in FIG. 2. By way of example, the evaluation information generating server 10 may further include a manager interface (not shown) through which preset information is input from a manager.

The communication unit 11 is configured to communicate with a user device or a shop device through a network. By way of example, the communication unit 11 receives an evaluation score or position information from the user device and transmits evaluation information to the user device. As another example, the communication unit 11 may receive an identifier of the user device and transmit the evaluation information to the shop device.

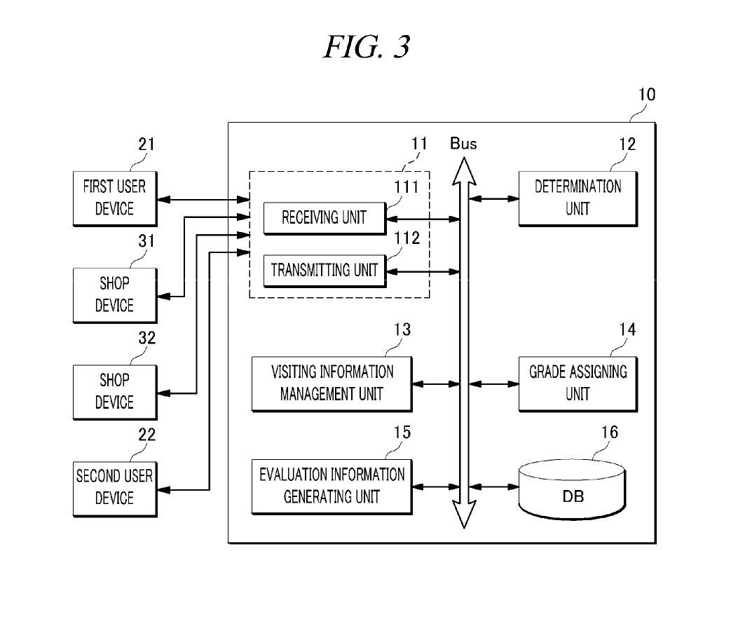

FIG. 3 is a block diagram for describing an operation of the evaluation information generating server according to an example embodiment of the present disclosure. As depicted in FIG. 3, the communication unit 11 may include a receiving unit 111 and a transmitting unit 112.

The receiving unit 111 is configured to receive position information of the device 21 of a first user from the device 21. Further, the receiving unit 111 may also be configured to receive position information of the shop 30 or the shop device 31 from the shop device 31 located in the shop 30.

The determination unit 12 is configured to determine whether the user device is located within the area of the shop. To this end, the determination unit 12 may determine whether the device 21 of the user is located within the area of the shop 30 based on at least one of the position information of the shop 30 or the shop device 31, and the position information of the device 21. Here, each of the position information of the shop 30 or the shop device 31 and the position information of the device 21 may be at least one of GPS (Global Positioning System) information, base station information and AP (Access Point) information. The position information of the shop 30 or the shop device 31 and the position information of the device 21 may be received from the shop device 31 or the device 21, respectively, or may be stored in a database 16.

An example operation of the determination unit 12 will be elaborated. In case that the position information is GPS information, the determination unit 12 may determine whether the device 21 is located within the area of the shop 30 by comparing GPS information of the device 21 and GPS information of the shop 30. Here, the GPS information includes, for example, GPS coordinates indicating a geographical position represented by x, y and z coordinates; and a time when the GPS coordinates are measured.

As another example operation of the determination unit 12, in case that the position information is base station information, the determination unit 12 determines whether the device 21 is located within the area of the shop 30 by determining whether a base station to which the device 21 is connected exists within the area or in the vicinity of the shop 30 based on information of the base station to which the device 21 is connected. Here, the base station information may be a network address or a physical address of the wireless communication base station to which the device 21 is connected.

As still another example operation of the determination unit, in case that the position information is AP information, the determination unit 12 may determine whether the device 21 located within the area of the shop 30 by determining whether an AP to which the device 21 is connected is installed in the shop 30 based on information of the AP to which the device 21 is connected. Here, the AP information may be a network address or a physical address of the AP to which the device 21 is connected.

Besides the aforementioned examples, the determination unit 12 may be operation in various other ways. By way of example, the determination unit 12 may determine whether the device 21 is located within the area of the shop 30 by comparing the base station information of the device 21 and the AP information of the shop 30.

Further, the determination unit 12 may also be configured to determine a time when the device 21 is located within the area of the shop 30 based on first position information and second position information of the device 21. For instance, the determination unit 12 recognizes first entry of the device 21 into the area of the shop 30, and acquires first position information of a first position which is recognized first; and a first time when the first position information is received. Later, the determination unit 12 recognizes deviation of the device 21 from the area of the shop, and acquires second position information of a second position which is recognized last; and a second time when the second position information is received. Finally, the determination unit 12 may determine a time (or a time interval) when the device 21 is located within the area of the shop 30 based on at least one of the first position information, the first time, the second position information and the second time.

This time (or the time interval) can be utilized to determine whether the user's current visit to the shop 30 is valid. For example, if the time (time interval) is within 10 minutes, it may be determined that the user's current visit to the shop 30 may not be valid.

Furthermore, the determination unit 12 may also be configured to determine whether the device 21 of the user is located within the area of the shop 30 based on an alarm received from the device 21. To this end, the device 21 may transmit an alarm indicating entry of the device 21 into the area of the shop 30 to the determination unit 12 after receiving an identifier of the shop 30 which is input through a user interface of the device 21 or after acquiring the identifier of the shop 30 through communications with the shop device 31. At this time, the alarm may include the identifier of the shop 30.

The visiting information management unit 13 is configured to record or update visiting information of the user. Specifically, the visiting information management unit 12 may record or update the visiting information of the user when it is determined by the determination unit that the device 21 of the user is located within the area of the shop 30.

The visiting information management unit 13 may record or update the visiting information of the user based on the time (or the time interval) when the device 21 of the user is located within the area of the shop 30. At this time, the visiting information management unit 13 may determine whether the user's current visit is a first type visit or a second type visit based on the time, and may update the visiting information based on the determination result.

According to one example embodiment, the first type visit may be a simple visit, and the second type visit may be a purchasing visit accompanying a purchase. Here, the simple visit may imply that the user (or user device) leaves the area of the shop 30 without performing an additional action such as purchasing a product after entering the area of the shop 30. The purchasing visit implies, on the other hand, that the user (or user device) leaves the area of the shop 30 after entering the area of the shop and purchasing a product.

If a payment process regarding the user is performed by the device 21 of the user or the shop device 31 of the shop 30, the visiting information management unit 13 determines that the user's visit is a second type visit, that is, a purchasing visit. For example, if a payment process for a certain service or a certain product of the shop 30 is performed by the user by means of the device 21, the visiting information management unit 13 may determine that the user's visit is a purchasing visit.

As another example, if the user performs a payment process for a certain service or a certain product of the shop 30 through the shop device 31, the visiting information management unit 13 may determine that the user's visit is a purchasing visit. At this time, an example of the shop device 31 may be a payment device located in the shop 30. As still another example, if an identifier of the device 21 is received from the shop device 31 or a shop device 32, the visiting information management unit 13 may determine that the user's visit is a purchasing visit. By way of non-limiting example, the shop device 32 may be a near field communication device capable of acquiring the identifier of the device 21 from the device 21 through near field communications when the device 21 approaches (or is tagging). Further, an example of the shop device 31 may be a payment device capable of acquiring the identifier of the device 21 from the device 21 and performing a payment process through near field communications when the device 21 approaches (or is tagging).

According to another example embodiment of the present disclosure, the first type visit may be a simple visit, and the second type visit may be a tag recognizing visit. Here, the simple visit may imply that the user (or the user device) leaves the area of the shop 30 without performing an additional action such as purchasing a product after entering the area of the shop 30. The tag recognizing visit implies that the user (or the user device) leaves the area of the shop 30 after the user (or the user device) enters the area of the shop 30 and the user device is tag-recognized by the shop device 31 or the shop device 32. At this time, the shop device 31 or the shop device 32 acquires an identifier of the device 21 by accessing to, tagging to or coming into contact with the device 21, and sends the acquired identifier of the device 21 to the visiting information management unit 13 through the receiving unit 111.

The visiting information management unit 13 is configured to count the number of visits (hereinafter, referred to as “visit count”) of the user (or the user device) whenever the user (or the user device) visits the shop 30. For example, when the device 21 of the user is located within the area of the shop and a visit count of the user (or the user device) recorded in the database 16 is fifteen (15), the visiting information management unit 16 may update the visit count of the user (or the user device) to sixteen (16). At this time, the visit count is an example of the visiting information. The visit count may be a count of valid visits. Alternatively, the visit count may be a sum of a count of valid visits and a count of invalid visits. In such a case, the sum may be a sum of a product of the count of valid visits and a first weighted value and a product of the count of invalid visit and a second weighted value. By way of non-limiting example, when the first weighted value is 1, the second weighted value may be 0.5.

The visiting information management unit 13 is also configured to record or update a frequency of the user (or the user device) by considering a number and a period of visits of the user (or the user device) to the shop 30. For example, when the device 21 of the user is located within the area of the shop and the visit count of the user (or the user device) recorded in the database 16 for the past 10 days (including the current date) is fifteen (15), the visiting information management unit 13 may record or update the frequency to “16 times/10 days”. Here, the frequency is another example of the visiting information.

The grade assigning unit 14 is configured to determine a grade of the user based on the visiting information of the user. As stated above, since one example of the visiting information is the visit count or the frequency, the grade assigning unit 14 may determine the grade of the user based on at least one of the visit count or the frequency of the user.

If the visit count of the user is equal to or larger than a threshold value, the grade assigning unit 14 assigns a regular customer grade to the user. For instance, if the visit count of the user is equal to or larger than fifteen (15) which is a threshold value, the grade assigning unit 14 may assign a regular customer grade to the user.

Alternatively, if the frequency (or visiting frequency) of the user is equal to or larger than a threshold value, the grade assigning unit 14 assigns a regular customer grade to the user. For example, if the frequency (or visiting frequency) of the user is equal to or larger than “1.5 times per day” which is a threshold value, the grade assigning unit 14 may assign a regular customer grade to the user.

The grade assigning unit 14 is also configured to determine grades of a plurality of users individually based on visiting information of the plurality of users. At this time, the grade assigning unit 14 assigns any one of 1 to N grades (N is a natural number) as a grade of each of the plurality of users. For example, the grade assigning unit may assign a first grade to a first user based on visiting information of the first user, and may assign a third grade to a second user based on visiting information of the second user.

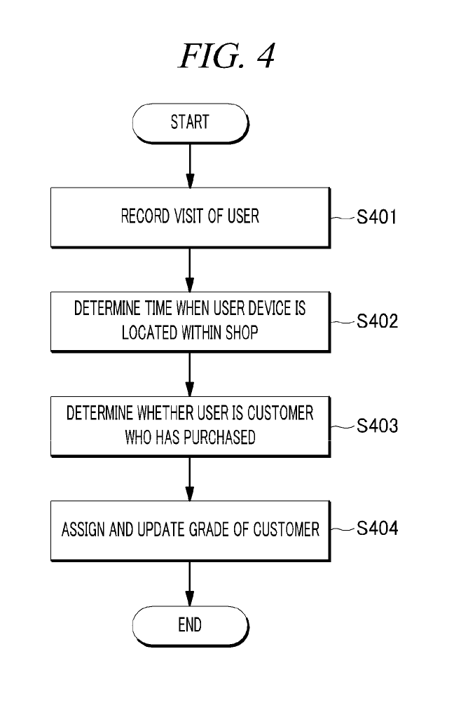

FIG. 4 is a flowchart for describing an example process of determining a grade of a customer. As depicted in FIG. 4, the example process of determining a grade of a customer includes steps S401 to S404. Each step is performed by one of the receiving unit 11, the determination unit 12, the visiting information management unit 13 and the grade assigning unit 14, but not limited thereto.

At step S401, the visiting information management unit 13 may record or update visiting information of a user (or a customer) with regard to the shop 30 when the user visits the shop 30 while carrying the device 21. At this time, the receiving unit 111 may receive position information from the device 21 of the user, and the determination unit 12 may recognize the fact that the user has visited the shop 30. Here, however, according to one example embodiment of the present disclosure, the user may select a visit to the shop 30 through the device 21, and as an alarm indicating the visit of the user is sent to the receiving unit 111 from the device 21, the determination unit 12 may recognize the visit of the user to the shop 30.

At step S402, the determination unit 12 is configured to calculate a time during which the user (or the user device) is located within the shop 30. At step S403, based on this calculated time, the visiting information management unit 13 may record or update, in the database 16, whether the user's current visit is valid or invalid. Generally, a valid visit may imply a visit where the user stays in the shop 30 for a preset period of time, or the user purchases a certain service or product. On the other hand, an invalid visit may imply a visit where the user stays in the shop 30 for less than the preset period of time, or the user does not purchase a certain service or product. In this regard, the step S403 may be a process of determining whether the user is a customer who has purchased in the shop 30 and recording or updating this determination result.

Also, the determination unit 12 is also configured to calculate a time difference (or a time interval) between a time when the user (or the user device) is first located within the area of the shop 30 and a time when the user (or the user device) leaves the area of the shop 30. The visiting information management unit 13 may regard the detected time difference as a period during which the user (or the user device) stays in the shop 30. If this staying time is equal to or larger than a threshold time (for example, 30 minutes), the visiting information management unit 13 may determine that the user's current visit is a valid visit, and record or update the visiting information while reflecting this determination result.

Further, regardless of the staying time, the visiting information management unit 13 may determine that the user (customer)'s current visit is a valid visit, if the user (or the customer) performs a payment process by using at least one of the device 21 and the shop device 31. Here, the valid visit may imply a purchasing visit where an actual purchasing process is performed.

Furthermore, regardless of the staying time, the visiting information management unit 13 determines that the user (customer)'s current visit is a valid visit or that the user (or the customer) is a customer who has purchased, if the user (or the customer) sends information indicating that that the user is a customer who has purchased by tagging their device 21 to a near field communication device within the shop 30.

The visiting information management unit 13 is also configured to record a cumulative visit count, a cumulative visit count for a preset time period, and a vising frequency within a preset period for each of the plurality of users (customers). For example, the visiting information management unit 13 may count visits of the first user to the shop 30 and record or update the cumulative visit count of the first user to thirty (30), the cumulative visit count within the recent 10 days to fifteen (15), and the visiting frequency within the recent 10 days to “1.5 times per day.”

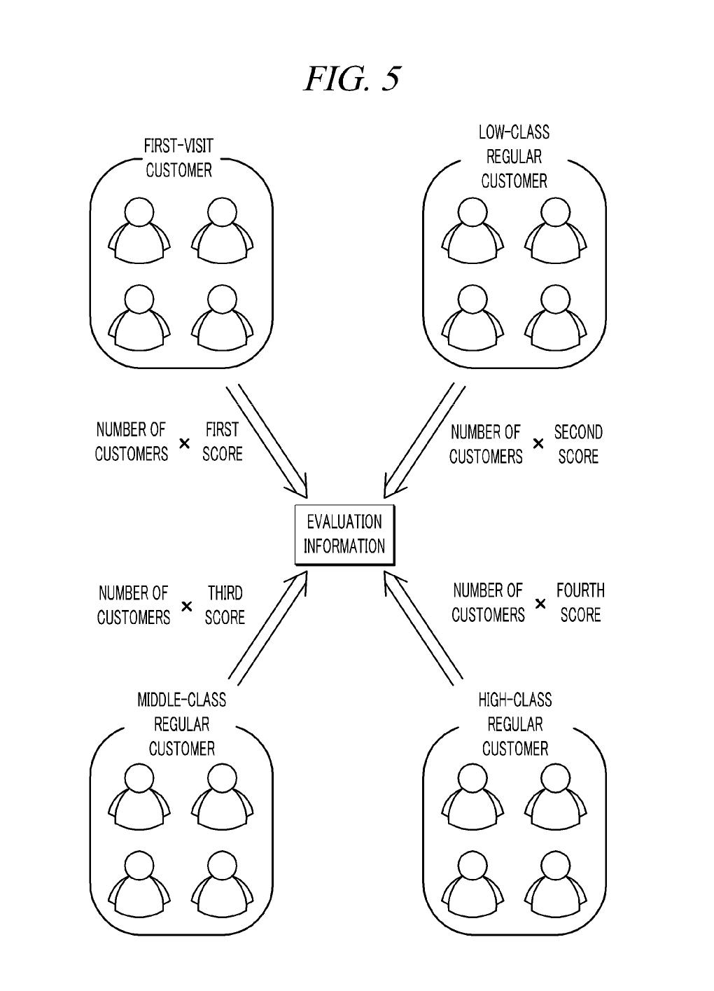

At step S404, the grade determination unit 14 is configured to determine grades of the users (or the customers) based on their visiting information. FIG. 5 is a diagram for describing a process of determining evaluation information of a shop according to weighted values per customer grade. Referring to FIG. 5, if a user is a customer who has visited a shop for the first time, the grade assigning unit 14 may assign a first-visit customer grade to the user. As another example, if a visit count of the user is equal to or more than two (2) and equal to or less than five (5), the grade assigning unit 14 may assign a low-class customer grade to the user; if the visit count of the user is equal to or more than six (6) and equal to or less than ten (10), the grade assigning unit 14 may assign a middle-class customer grade to the user and if the visit count of the user is equal to or more than eleven (11), the grade assigning unit 14 may assign a high-class customer grade to the user.

The grade determination unit 14 may determine a grade of each of the plurality of users based on at least one of the cumulative visit count, the cumulative visit count within the preset period and the visiting frequency within the preset period of each of the plurality of users.

The evaluation information generating unit 15 is configured to generate evaluation information of the shop based on the grades of the plurality of users. As described above, the grade of each of the plurality of users is determined based on the number or the frequency of each user's visits to the shop 30. For example, since some of the plurality of users have visited the shop a preset number of times or more, they are assigned a regular customer grade. According to one example embodiment of the present disclosure, the evaluation information of the shop 30 may be the number of users that have been assigned the regular customer grade, i.e., the number of regular customers. If the number of the regular customers is displayed on another user's device, this user can be informed of how many regular customers the shop 30 has. Accordingly, the user can be given objective and reliable information of the shop.

According to one example embodiment of the present disclosure, the evaluation information may further include the number of customers for each visit count, in addition to the number of regular customers. If the number of customers for each visit count is displayed on another user's device, this user can be informed of whether the customers having visited the shop 30 is one-time customers or regular customers who visits the shop 30 repeatedly.

Furthermore, the evaluation information may further include detailed reviews of the users who have given the regular customer grade. Here, the detailed reviews may be included in individual evaluations sent from a plurality of user devices to the receiving unit 111, respectively. If the detailed reviews are displayed on another user's device, this user can check the detailed reviews of the regular customers in real time.

The evaluation information generating unit 15 may generate the evaluation information based on a score corresponding to the grade of each of the plurality of users. For example, the evaluation information generating unit 15 may determine that a score of a first user is 100 points when the grade of the first user is a first grade and that a score of a second user is 80 points when the grade of the second user is a third grade. Then, the evaluation information generating unit 15 may set a sum (180 points) of these scores or an average (90 points) of these scores as evaluation information of the shop 30.

The evaluation information generating unit 15 is configured to generate the evaluation information of the shop 30 based on an evaluation score received from the device 21 of the user and a grade of the user. For example, if the evaluation score received from the device 21 of the user is 70 points and the grade of the user is a regular customer grade, the evaluation information generating unit 15 may add 10 points to the received evaluation score and sets 80 points as the evaluation information of the shop 30. At this time, the evaluation score may be included in an individual evaluation transmitted from the device 21 of the user to the receiving unit 111. The individual evaluation may include a review or a comment of the user as well as the evaluation score.

As another example, if the evaluation score received from the device 21 of the user is five (5) star points of maximum ten (10) star points and the user is a first-visit customer grade, one start point is deleted, and four (4) start points is set as the evaluation information of the shop 30. Although the evaluation information may be generally an evaluation score with regard to the shop 30, the evaluation information may further include at least one of a review or comment of the user, a comment of another user, and promotional material of the shop 30.

Further, the evaluation information generating unit 15 may generate evaluation information of the shop 30 based on evaluation scores of the plurality of users with regard to the shop 30. For example, the evaluation information generating unit 15 may generate evaluation information by using a sum or an average of a plurality of evaluation scores of the plurality of users with regard to the shop 30. At this time, the receiving unit 111 may receive the individual evaluation scores from the plurality of users, respectively, and the received evaluation scores are stored in the database 16. In general, each evaluation score is stored by being mapped with an identifier of a corresponding user.

Further, the evaluation information generating unit 15 may generate evaluation information of the shop 30 based on evaluation scores respectively received from the plurality of users and grades of the plurality of users. Here, a weighted value per user grade is applied to the evaluation score of each of the plurality of users, and a value obtained by dividing a sum total of the evaluation scores by the number of the plurality of users is generated as the evaluation information. That is, by applying weighted values to the evaluation scores of the plurality of users according to the grades of the users, the evaluation information of the shop 30 can be generated.

Furthermore, the evaluation information generating unit 15 may generate evaluation information of the shop 30 based on a tendency of a user, a grade of the user and an evaluation score with regard to the shop 30. As an example, the tendency may be a taste, a preference, an age, a gender, a hobby, or a specialty of the user.

The evaluation information generating unit 15 may apply a weighted value to a score or an evaluation score of the user when the tendency of the user is related to a product or a service of the shop 30. For example, if the user tends to like spicy food and the shop 30 sells spicy foods, the evaluation information generating unit 15 may generate the evaluation information of the shop 30 by applying a weighted value to the score or the evaluation score of the user. As another example, if the user is a woman and the shop 30 is a store which sells cosmetic products, the evaluation information generating unit 15 may generate the evaluation information of the shop 30 by applying a weighted value to the score or the evaluation score of the user.

The transmitting unit 112 is configured to transmit the evaluation information of the shop 30 to at least one of the shop device 31, the shop device 32, and the plurality of devices including the first user device 21 and the second user device 22.

The transmitting unit 112 may transmit a reward or target information to the device 21 based on the grade of the user. Here, the reward may be, for example, a coupon or information of service and product, and the target information may be, for example, a target advertisement of the shop 30, a target advertisement of a category to which the shop 30 belongs, or a local advertisement of an area where the shop 30 is located.

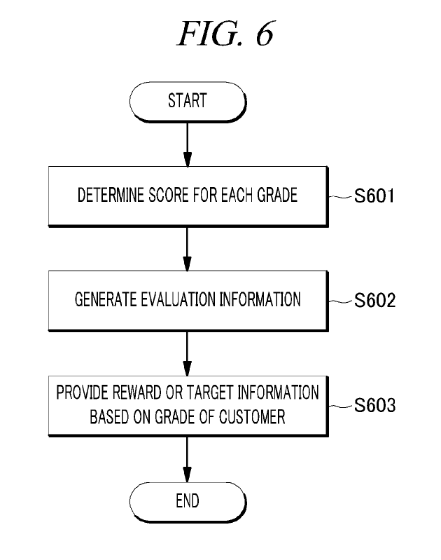

FIG. 6 is a flowchart for describing an example process of generating evaluation information. As shown in FIG. 6, the example process of generating evaluation information may include steps S601 to S603. Each step is performed by the evaluation information generating unit 15 or the transmitting unit 112, but not limited thereto.

At step S601, the evaluation information generating unit 15 may determine a score of each of a plurality of users based on a grade of each of the plurality of users. Here, the score may be expressed as a weighted value.

At step S602, the evaluation information generating unit 15 may generate evaluation information based on the scores of the plurality of users. According to one example embodiment of the present disclosure, however, the evaluation information generating unit 15 may generate evaluation information of the shop 30 at step S602 based on grades of the users, evaluation scores respectively received from the users, and weighted values for each grade of the users.

Referring to FIG. 5, the evaluation information generating unit 15 may generate evaluation information of the shop 30 based on customer grades of the plurality of users (or customers) and the numbers of customers per customer grade. At this time, the evaluation information generating unit 15 applies a score which depends on a grade of a user. For example, the evaluation information generating unit 15 may determine that a first score (or weighed value) corresponding to a first-visit customer grade is 50 points; a second score (or weighted value) corresponding to a low-class regular customer grade is 70 points; a third score (or weighted value) corresponding to a middle-class regular customer grade is 80 points; and a fourth score (or weighted value) corresponding to a high-class regular customer grade is 100 points. The evaluation information generating unit 15 may generate the evaluation information of the shop 30 by using a score averaging method in which the numbers of customers belonging to each grade are reflected.

As an example, if the number of customers of the first-visit customer grade is ten (10); the number of customers of the low-class regular customer grade is ten (10); the number of customers of the middle-class regular customer grade is ten (10); and the number of customers of the high-class regular customer grade is ten (10), the evaluation information of the score 30 may be determined by the following Equation 1.

Evaluation information of shop 30=75=(10*50+10*70+10*80+10*100)/(10+10+10+10) [Equation 1]

Accordingly, a shop having a large number of customers having high customer grades is given higher evaluation score, and, thus, the evaluation information provided to the customers has higher reliability.

At step S603, the transmitting unit 112 may transmit a reward or target information to the device 21 of a user based on a grade of the user. Here, the reward may be, for example, a coupon or information of service and product, and the target information may be, for example, a target advertisement of the shop 30, a target advertisement of a category to which the shop 30 belongs, or a local advertisement of an area where the shop 30 is located. As this reward or target information is provided differently based on the grade of the user, it is possible to perform promotion and target marketing by customer grades. Furthermore, by informing the shop device 31 or an additional customer management server (not shown) of a visit of a customer according to a grade (for example, a high-class regular customer grade) of the customer, the evaluation information generating server 10 may provide customized services by customer grades.

The database 16 is configured to store data therein. Here, the date includes data generated by individual constituent components within the evaluation information generating server 10 or data input and output between the individual constituent components within the evaluation information generating server 10. Further, the data also includes data input and output between the evaluation information generating server 10 and constituent components outside the evaluation information generating server 10. For example, the database 16 stores visiting information output from the visiting information management unit 13, grades output from the grade assigning unit 14 and scores received from the device 21. By way of example, the database 16 may be, but not limited to, a hard disk drive, a ROM (Read Only Memory), a RAM (Random Access Memory), a flash memory, or a memory card which exists within or outside the evaluation information generating server 10.

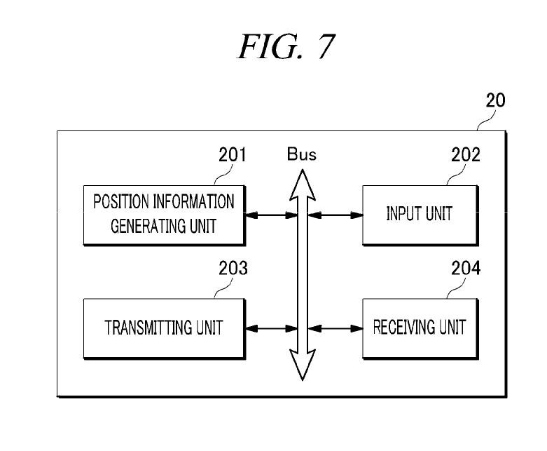

FIG. 7 is a block diagram of a device according to an example embodiment of the present disclosure. As depicted in FIG. 7, a device 20 includes a position information generating unit 201, an input unit 202, a transmitting unit 203 and a receiving unit 204. The device 20 corresponds to the devices described in FIG. 1 to FIG. 6 (for example, the devices 21 to 24). Thus, though omitted below, the description provided for the devices in FIG. 1 to FIG. 5 (for example, the devices 21 to 24) is also applied to FIG. 7.

The position information generating unit 201 may transmit position information of the device 20 to the evaluation information generating server 10 when the device 20 is located within the area of the shop 30.

The input unit 202 may receive a first evaluation of the shop 30 which is input through a user interface. Here, the first evaluation may include at least one of an individual evaluation, an evaluation score and a detailed review as stated above. Further, the user interface may be implemented by a hardware button, a voice recognition interface, a gesture recognition interface, a touch interface, or the like.

The transmitting unit 203 may transmit the first evaluation to the evaluation information generating server 10. The receiving unit 204 may receive evaluation information of the shop 30 from the evaluation information generating server 10. At this time, the evaluation information is determined or changed based on the first evaluation and a grade of the user of the device 20. Further, the evaluation information is determined or changed based on a plurality of evaluations and grades of a plurality of users.

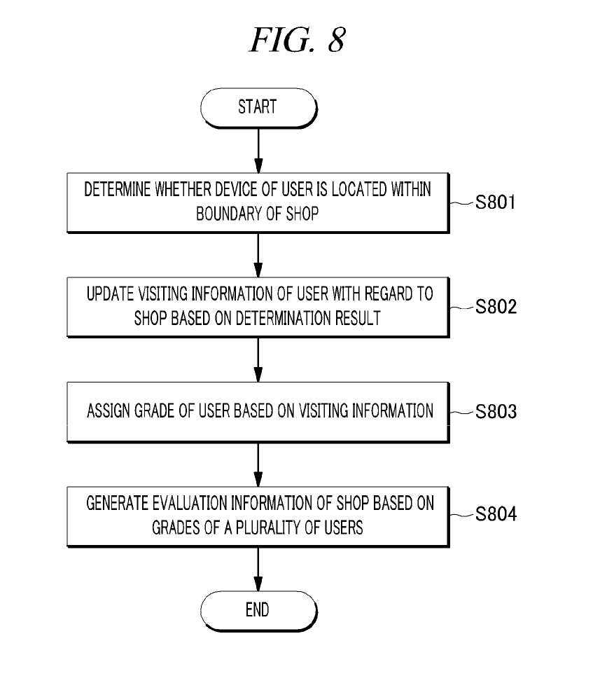

FIG. 8 is a flowchart for describing a method of generating evaluation information according to an example embodiment of the present disclosure. The method of generating evaluation information depicted in FIG. 8 includes processing steps that are performed in a time series. Though omitted below, the description provided for the evaluation information generating server 10 in FIG. 1 to FIG. 7 is also applied to FIG. 8.

At step S801, the determination unit 12 may determine whether a user device is located within an area of a shop. At step S802, based on the determination result, the visiting information management unit 13 may update visiting information of the user with regard to the shop. At step S803, the grade assigning unit 14 may assign a grade of the user based on the visiting information. At step S804, the evaluation information generating unit 15 may generate evaluation information of the shop based on grades of a plurality of users.

Though not shown in FIG. 8, according to one example embodiment of the present disclosure, the method of generating evaluation information further includes a process of receiving an evaluation score of the user with regard to the shop from the user device. In this case, at step S804, the evaluation information generating unit 15 may generate evaluation information of the shop based on scores of a plurality of users and grades of the plurality of users.

Though not shown in FIG. 8, according to one example embodiment of the present disclosure, the method of generating evaluation information may further include a process of transmitting the evaluation information to a plurality of devices of the plurality of users and a shop device.

Thought not depicted in a drawing, according to one example embodiment of the present disclosure, a device control method is also provided. The device control method includes processing steps performed in the device shown in FIG. 7 in a time series. Accordingly, in the following description of the device control method, the same description as provided above for the device 20 throughout FIG. 1 to FIG. 7 will be omitted.

The device control method according to the example embodiment of the present disclosure includes transmitting position information of a device to the evaluation information generating server when the device is located within an area of a preset shop; receiving a first evaluation of the shop which is input through a user interface; transmitting the first evaluation to the evaluation information generating server; and receiving the evaluation information of the shop from the evaluation information generating server. Here, the evaluation information may be changed based on the first evaluation and a grade of a user of the device.

The method of generating evaluation information and the device control method as described above can be embodied in a storage medium including instruction codes executable by a computer or processor such as a program module executed by the computer or processor. A computer readable medium can be any usable medium which can be accessed by the computer and includes all volatile/nonvolatile and removable/non-removable media. Further, the computer readable medium may include all computer storage and communication media. The computer storage medium includes all volatile/nonvolatile and removable/non-removable media embodied by a certain method or technology for storing information such as computer readable instruction code, a data structure, a program module or other data. The communication medium typically includes the computer readable instruction code, the data structure, the program module, or other data of a modulated data signal such as a carrier wave, or other transmission mechanism, and includes information transmission mediums.

The above description of the example embodiments is provided for the purpose of illustration, and it would be understood by those skilled in the art that various changes and modifications may be made without changing technical conception and essential features of the example embodiments. Thus, it is clear that the above-described example embodiments are illustrative in all aspects and do not limit the present disclosure. For example, each component described to be of a single type can be implemented in a distributed manner. Likewise, components described to be distributed can be implemented in a combined manner.

The scope of the inventive concept is defined by the following claims and their equivalents rather than by the detailed description of the illustrative embodiments. It shall be understood that all modifications and embodiments conceived from the meaning and scope of the claims and their equivalents are included in the scope of the inventive concept.

1. A server that generates evaluation information, comprising:
a determination unit configured to determine whether a device of a user is located within an area of a shop;
a visiting information management unit configured to update visiting information of the user with regard to the shop based on the determination result;
a grade assigning unit configured to assign a grade of the user based on the visiting information; and
an evaluation information generating unit configured to generate evaluation information of the shop based on grades of a plurality of users.

2. The server of claim 1,
wherein the evaluation information generating unit is further configured to determine a score of the user based on the grade of the user and generate the evaluation information of the shop based on scores of the plurality of users.

3. The server of claim 1,
wherein the visiting information includes at least one of a number of visits and a frequency of visits, and
the grade assigning unit is further configured to assign the grade of the user based on at least one of the number of visits and the frequency of visits.

4. The server of claim 3,
wherein the grade assigning unit is further configured to assign a regular customer grade to the user when the number of visits is equal to or larger than a threshold value.

5. The server of claim 1, further comprising:
a receiving unit configured to receive a score of the user with regard to the shop from the device of the user,
wherein the evaluation information generating unit is further configured to generate the evaluation information of the shop based on the grades of the plurality of users and scores of the plurality of users.

6. The server of claim 5,
wherein the evaluation information generating unit is further configured to generate the evaluation information by applying a weighted value to each of the scores of the plurality of users according to the grade of each of the plurality of users, and
the grade of each of the plurality of users is any one of a first grade, a second grade and a third grade.

7. The server of claim 1,
wherein the determination unit is further configured to determine whether the device of the user is located within the area of the shop based on at least one of position information of the shop and position information of the device.

8. The server of claim 7,
wherein the position information is at least one of GPS (Global Positioning System) information, base station information of the device and AP (Access Point) information of the device.

9. The server of claim 7,
wherein the determination unit is further configured to calculate a time during which the device of the user is located within the area of the shop based on first position information and second position information of the device, and
the visiting information management unit is further configured to update the visiting information of the user based on the time.

10. The server of claim 9,
wherein the visiting information management unit is further configured to determine whether a visit of the user is a first type visit or a second type visit based on the time, and is further configured to update the visiting information based on the determination result.

11. The server of claim 10,
wherein the first type visit is a simple visit, whereas the second type visit is a purchasing visit.

12. The server of claim 10,
wherein the visiting information management unit is further configured to determine that the visit of the user is the second type visit when a payment process is performed by the device of the user or by a payment device of the shop.

13. The server of claim 10,
wherein the visiting information management unit is further configured to determine that the visit of the user is the second type visit when an identifier of the device of the user is received from a near field communication device of the shop.

14. The server of claim 1, further comprising:
a transmitting unit configured to transmit the evaluation information to a plurality of devices of a plurality of users and a device of the shop.

15. The server of claim 14,
wherein the transmitting unit is further configured to transmit a reward or target information to the device of the user based on the grade of the user.

16. The server of claim 1,
wherein the determination unit is further configured to determine whether the device of the user is located within the area of the shop based on an alarm received from the device of the user.

17. The server of claim 5,
wherein the evaluation information generating unit is further configured to generate the evaluation information of the shop based on a tendency of the user, the grade of the user and the score of the user.

18. A method of generating evaluation information, comprising:
determining whether a device of a user is located within an area of a shop;
updating visiting information of the user with regard to the shop based on the determination result;
assigning a grade of the user based on the visiting information; and
generating evaluation information of the shop based on the grade of the user.

19. The method of claim 18, further comprising:
receiving a score of the user with regard to the shop from the device of the user,
wherein the generating of the evaluation information comprises generating the evaluation information of the shop based on scores of a plurality of users and grades of the plurality of users.

20. The method of claim 18, further comprising:
transmitting the evaluation information to a multiplicity of devices of the plurality of users and a device of the shop.

21. A computer-readable recording medium having stored thereon a program for implementing a method as claimed in claim 18 on a computer.

22. A device, comprising:
a transmitting unit configured to transmit position information of the device to an evaluation information generating server when the device is located within an area of a shop;
an input unit configured to receive a first evaluation of the shop which is input through a user interface;
a transmitting unit configured to transmit the first evaluation to the evaluation information generating server; and
a receiving unit configured to receive evaluation information of the shop from the evaluation information generating server,
wherein the evaluation information is changed based on the first evaluation and a grade of a user of the device.
